(19) United States
(12) Patent Application Publication
(10) Pub. No.: US 2009/0193330 A1
(43) Pub. Date: Jul. 30, 2009

(54) Method of accessing files with XML documents of windows format under Linux

(76) Inventor: Yu-Liang Sun, Taipei City (TW)

Correspondence Address: Chih Feng Yeh;BRIAN M. MCINNIS, 12th Floor, Ruttonjee House, 11 Duddell Street, Hong Kong, HK

(21) Appl. No.: 12/076,286

(22) Filed: Mar. 17, 2008

(30) Foreign Application Priority Data
Jan. 28, 2008 (TW) 97103163

(51) Int. Cl. G06F 17/00

(52) U.S. Cl. 715/239

(57) ABSTRACT

This present invention is a method of accessing files with XML documents of Windows format under Linux, converting the XML documents of Windows format into the XML documents of Linux format, thus a web browser of Linux is able to download driver programs or to install programs from a data CD by the XML document of Linux format.

### RELATED APPLICATIONS

This application claims priority to Taiwan Application Serial Number 97103163, filed Jan. 28, 2008, which is herein incorporated by reference.

### BACKGROUND

1. Field of Invention

This present invention is a method of accessing files with XML documents of Windows format under Linux. More particularly, the present invention a method of accessing files with XML documents of different operating system formats.

2. Description of Related Art

Under Windows and Linux operating system, the expressions of file paths are different. If a user wills to retrieve a file from an Extensible Markup Language (XML) document, it is required to erect a web server on the local end computer. Then by linking to the web server through a web browser of the local end computer, the web browser can retrieve the file according to the file paths in a XML document.

In prior art, it requires extra web server software to erect a web server on the local end computer for retrieving the file by a web browser linking to a web server. Because the web server would hold a network service, it does not only consume computer resources, but the procedure of retrieving a file is complicated and time-consuming. And there is a security concern when erecting a web server on the local end computer.

For instance, when applying the practice of prior art on a practical server; it will hold a network service when downloading some drivers or system tools. An old version or insecure server software may be carried out on the server computer, and caused security threats.

### SUMMARY

For this reason, the present invention provides a method of accessing files with XML documents of Windows format under Linux. By converting a first XML document of Windows format to a second XML document of Linux format, and by engaging with the Link function of the file linkage structure of Linux, a user under Linux can retrieve the specific installation files and drivers through the web browser by clicking on hyperlinks in a XML document of Windows format.

The main idea to this invention is to open a webpage enclosing a XML document of Windows format or a webpage enclosing a XML document of Linux format by using a web browser. And by the Link function of the file linkage structure of Linux, the system actually retrieves the specific file stored on a data CD by the absolute path, which is conducted from the relative path in a XML document of Linux format. Wherein the absolute path is a path that points to the same location on one file system regardless of the working directory or combined paths, and is usually written in reference to a root directory. And the relative path is a path relative to the current working directory, so the full absolute path may not need to be given. Therefore, it is able to retrieve the installation files and drivers on data CDs by clicking on hyperlinks in a webpage through a web browser.

By means of this invention, installing the web server software to erect a web server for a web browser to open a webpage enclosing a XML document of s Windows format or of Linux format through is taken place.

### BRIEF DESCRIPTION OF THE DRAWINGS

The invention can be more fully understood by reading the following detailed description of the embodiment, with reference made to the accompanying drawings as follows:

FIG. 1 is the flowchart of the method of accessing files with XML documents of Windows format under Linux of this invention.

FIG. 2 is the flowchart of detailed procedures of accessing a specific file by clicking on the hyperlink of the specific file in the webpage of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

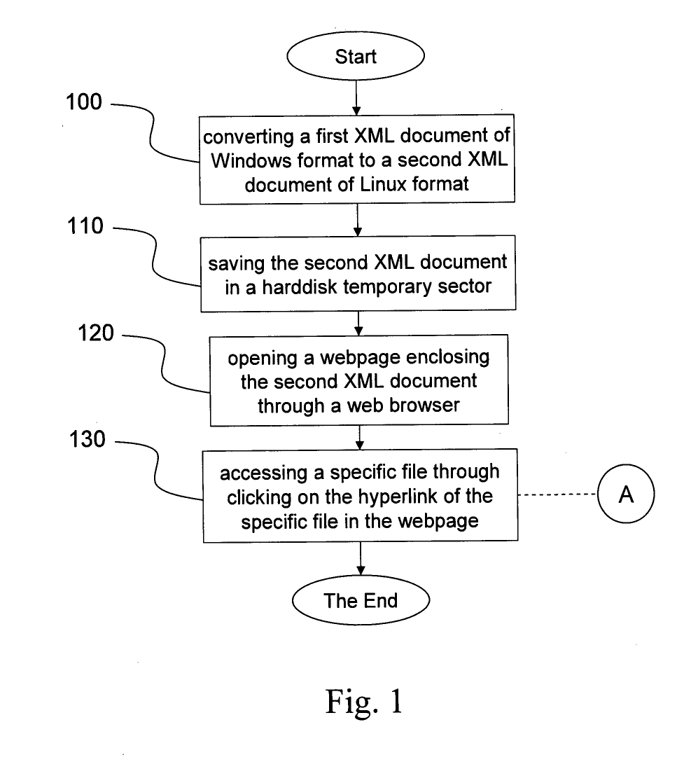

Refer to FIG. 1. FIG. 1 is the flowchart of the method of accessing files with XML documents of Windows format under Linux of this invention. As shown in FIG. 1, when accessing files with XML documents of Windows format under Linux, a path format converting module converts a first XML document of Windows format to a second XML document of Linux format by a path format converting module (Step 100). Then, the second XML document will be saved into a hard disk temporary sector (Step 110). Then, a user opens a webpage enclosing the second XML document by using a web browser (Step 120), and accesses a specific file by clicking on the hyperlink of the specific file in the webpage (Step 130). The above-mentioned first XML document is stored on a data CD and is a document of the Extensible Markup Language with Windows formatted links for downloading files. The above-mentioned second XML document is a document of the Extensible Markup Language with Linux formatted links for downloading files. Also, the second XML document is converted by a path format converting module, and then saved into the hard disk temporary sector in Step 110.

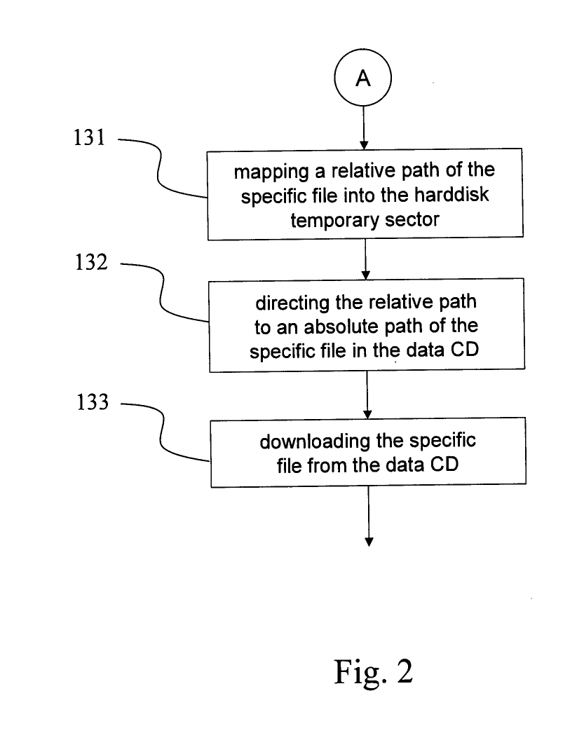

In addition, the above-mentioned Step 130 further comprises a detailed procedure A. Refer to FIG. 2. FIG. 2 is the flowchart of a detailed procedure of accessing a specific file by clicking on the hyperlink of the specific file in the webpage of this invention. As shown in FIG. 2, in the detailed procedure A, a relative path of the specific file is mapped into the hard disk temporary sector (Step 131). Then, the web browser directs the relative path to an absolute path of the specific file in the data CD (Step 132), and then the web browser downloads the specific file from the data CD (Step 133). After finishing downloading the specific file, the procedure A is finished. Wherein the absolute path is a path that points to the same location on one file system regardless of the working directory or combined paths, and is usually written in reference to a root directory. And the relative path is a path relative to the current working directory, so the full absolute path may not need to be given. In Step 132, directing the relative path to an absolute path of the specific file in the data CD is applied with the Link function of the file structure of Linux. That is, when referring to the relative path of the specific file in the XML document of Linux format, the absolute path directing to the specific file in a data CD is in fact conducted by the system. Then the system retrieves and downloads the specific file stored on the data CD.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of accessing files with XML documents of Windows format under Linux, comprising following steps:
converting a first XML document of Windows format to a second XML document of Linux format;
saving the second XML document in a hard disk temporary sector;
opening a webpage enclosing the second XML document by using a web browser; and
accessing a specific file by clicking on the hyperlink of the specific file in the webpage.

2. The method of accessing files with XML documents of Windows format under Linux of claim 1, wherein the first XML document is a document of the Extensible Markup Language with Windows formatted links for downloading files.

3. The method of accessing files with XML documents of Windows format under Linux of claim 2, wherein the first XML document is stored on a data CD.

4. The method of accessing files with XML documents of Windows format under Linux of claim 1, wherein the second XML document is a document of the Extensible Markup Language with Linux formatted links for downloading files.

5. The method of accessing files with XML documents of Windows format under Linux of claim 4, wherein the specific file is stored on a data CD.

6. The method of accessing files with XML documents of Windows format under Linux of claim 1, wherein converting the first XML document of Windows format to the second XML document of Linux format is applied by a path format converting module.

7. The method of accessing files with XML documents of Windows format under Linux of claim 1, wherein accessing a specific file by clicking on the hyperlink of the specific file in the webpage comprises following steps:
mapping a relative path of the specific file into the hard disk temporary sector;
directing the relative path to an absolute path of the specific file in the data CD; and
downloading the specific file from the data CD.

8. The method of accessing files with XML documents of Windows format under Linux of claim 7, wherein directing the relative path to an absolute path of the specific file in a data CD is applied with the Link Function of the file structure of Linux.

9. A method of accessing files with XML documents of Windows format under Linux, comprising following steps:
converting a first XML document of Windows format stored in a data CD to a second XML document of Linux format by a path format converting module;
saving the second XML document in a hard disk temporary sector;
opening a webpage enclosing the second XML document by using a web browser;
clicking on the hyperlink of the specific file in the webpage;
mapping a relative path of the specific file into the hard disk temporary sector;
directing the relative path to an absolute path of the specific file in the data CD; and
downloading the specific file from the data CD.

10. The method of accessing files with XML documents of Windows format under Linux of claim 9, wherein the first XML document is a document of the Extensible Markup Language with Windows formatted links for downloading files.

11. The method of accessing files with XML documents of Windows format under Linux of claim 9, wherein the second XML document is a document of the Extensible Markup Language with Linux formatted links for downloading files.

12. The method of accessing files with XML documents of Windows format under Linux of claim 9, wherein directing the relative path to an absolute path of the specific file in the data CD is applied with the Link Function of the file structure of Linux.
